(19) United States
(12) Patent Application Publication
(10) Pub. No.: US 2026/0296417 A1
(43) Pub. Date: Oct. 1, 2026

(54) METHOD AND SYSTEM FOR PREVENTING DEACTIVATION OF AUTONOMOUS EMERGENCY BRAKING SYSTEM OF VEHICLE

(71) Applicant: HL Klemove Corp., Incheon (KR)

(72) Inventor: Gwangyong JUNG, Incheon (KR)

(21) Appl. No.: 19/297,139

(22) Filed: Aug. 12, 2025

(30) Foreign Application Priority Data
Mar. 28, 2025 (KR) 10-2025-0039972

(51) Int. Cl. B60W 30/095; B60W 30/09

(52) U.S. Cl. CPC B60W 30/0956; B60W 30/09; B60W 2420/403; B60W 2420/408; B60W 2540/10; B60W 2540/18; B60W 2556/50

(57) ABSTRACT

A method of preventing deactivation of an Autonomous Emergency Braking (AEB) system of a vehicle includes: determining whether the vehicle is driving on a turnable road on which the vehicle is able to make a turn; recognizing a target on a driving path of the vehicle; determining whether the vehicle satisfies a predetermined turning condition; determining whether a driver of the vehicle has operated an accelerator pedal of the vehicle; and in response to determining that (i) the vehicle is driving on the turnable road, (ii) the recognized target is on the driving path of the vehicle, (iii) the vehicle satisfies the predetermined turning condition and (iv) the driver has operated the accelerator pedal, releasing a deactivation condition of the AEB system due to operation of the accelerator pedal in order to prevent deactivation of the AEB system.

### CROSS-REFERENCE TO RELATED APPLICATION

This application claims the benefit of and priority to Korean Patent Application No. 2025-0039972 filed on Mar. 28, 2025, the entire disclosures of which are incorporated herein by reference.

### TECHNICAL FIELD

The present disclosure relates to a method and system for preventing deactivation of an Autonomous Emergency Braking (AEB) system of a vehicle. More specifically, the present disclosure relates to a method and system for preventing deactivation of an Autonomous Emergency Braking (AEB) system of a vehicle configured to prevent the AEB system from being deactivated by accelerator pedal misoperation during turning of an ego vehicle.

### BACKGROUND

In a vehicle, a Driver Assistance System provides support to a driver while driving in the vehicle for the driver's convenience.

For example, an Autonomous Emergency Braking (AEB) system refers to a function that reduces collision risk by automatically braking when the vehicle detects a risk of a front collision.

Meanwhile, due to increased complexity at intersections and blind spots, there is a high possibility of sudden situations occurring when the vehicle is turning at intersections, parking lot entrances or exits, etc.

In particular, as personal mobility devices such as electric kickboards and bicycles become popular, and especially due to the high speed and maneuverability of these mobility devices, situations frequently occur where these mobility devices approach intersections, parking lot entrances or exits, etc., from directions that are difficult for the driver of the vehicle to anticipate.

Meanwhile, existing AEB systems do not intervene in the vehicle's behavior when the driver operates the accelerator pedal, assuming it is an intention to avoid collision. Therefore, there is a problem in that the AEB system is deactivated by accelerator pedal operation due to the driver's misrecognition of pedals in a sudden situation.

In particular, elderly drivers have a high possibility of confusing the accelerator pedal and the brake pedal in sudden situations due to decreased cognitive ability and reflexes. Since accidents due to such pedal misrecognition primarily occur when the accelerator pedal is mistakenly pressed, there is a high possibility of causing serious damage by collision occurring in a state of sudden acceleration.

Therefore, there is a need for a method and system for preventing deactivation of an Autonomous Emergency Braking system to prevent AEB system deactivation due to the driver's misoperation of the accelerator pedal in a turning situation of the vehicle.

### SUMMARY

The present disclosure is to solve the problems of the prior art described above, and an object of the present disclosure is to provide a method and system for preventing deactivation of an Autonomous Emergency Braking (AEB) system that prevents AEB system deactivation according to road conditions and turning conditions during driving of an ego vehicle.

Furthermore, an object of the present disclosure is to provide a method and system for preventing deactivation of the AEB system that prevents AEB system deactivation according to the degree of accelerator pedal operation when the ego vehicle satisfies road conditions and turning conditions during driving.

However, the technical problems to be achieved by the embodiments of the present disclosure are not limited to the technical problems described above, and other technical problems may exist.

As a technical means for achieving the above technical problem, a method for preventing deactivation of an Autonomous Emergency Braking (AEB) system of a vehicle according to an embodiment of the present disclosure comprises: determining whether the vehicle is driving on a turnable road on which the vehicle is able to make a turn; recognizing a target on a driving path of the vehicle; determining whether the vehicle satisfies a predetermined turning condition; determining whether a driver of the vehicle has operated an accelerator pedal of the vehicle; and in response to determining that (i) the vehicle is driving on the turnable road, (ii) the recognized target is on the driving path of the vehicle, (iii) the vehicle satisfies the predetermined turning condition and (iv) the driver has operated the accelerator pedal, releasing a deactivation condition of the AEB system due to operation of the accelerator pedal in order to prevent deactivation of the AEB system.

Further, the determining whether the vehicle is driving on the turnable road may comprise: collecting information from navigation map data or cloud map data; determining whether a driving road of the vehicle is the turnable road based on the collected information; and transmitting a turning section entry signal in response to determining that the driving road of the vehicle is the turnable road.

Further, the turnable road may be an intersection, an entrance or exit of a parking lot, or a road within a residential complex.

Further, the recognizing of the target may comprise determining whether there is a collision risk with the vehicle according to a predicted path of the target.

Further, the target may be another vehicle in front of the vehicle, a pedestrian, a bicycle, or an electric kickboard.

Further, the determining whether the vehicle satisfies the predetermined turning condition may comprise: determining whether a speed of the vehicle is less than or equal to a predetermined threshold value; determining whether a steering angle of the vehicle is greater than or equal to a predetermined angle; and in response to determining that the speed of the vehicle is less than or equal to a predetermined threshold value and the steering angle of the vehicle is greater than or equal to the predetermined angle, determining that the vehicle satisfies the predetermined turning condition.

Further, the predetermined threshold value for the speed of the vehicle may be 30 km/h.

Further, the determining whether the driver of the vehicle has operated the accelerator pedal may be performed by an accelerator pedal sensor equipped in the vehicle, the accelerator pedal sensor sensing whether the accelerator pedal is operated.

The method may further comprise: in response to determining that the driver of the vehicle has operated the accelerator pedal, determining whether acceleration of the vehicle is greater than or equal to a predetermined acceleration, wherein the releasing of the deactivation condition of the AEB system is performed in response to determining that the acceleration of the vehicle is greater than or equal to the predetermined acceleration.

The method may further comprise: after the deactivation condition of the AEB system is released by the releasing of the deactivation condition of the AEB system, and in response to a predetermined AEB system operation condition being satisfied for the target, performing at least one of a warning control or a braking control according to the AEB system for the vehicle.

A system for preventing deactivation of an Autonomous Emergency Braking (AEB) system of a vehicle according to embodiments of the present disclosure comprises: a first sensor configured to recognize a target on a driving path of the vehicle; a second sensor configured to provide body information of the vehicle; and a controller configured to control the AEB system of the vehicle, wherein when the vehicle is driving on a turnable road, the controller is configured to determine whether the vehicle satisfies a predetermined turning condition, determine whether a driver of the vehicle has operated an accelerator pedal of the vehicle, and in response to determining that the vehicle satisfies the predetermined turning condition and the driver has operated the accelerator pedal, release a deactivation condition of the AEB system due to accelerator pedal operation in order to prevent deactivation of the AEB system.

The system may further comprise: a map information provider configured to provide data regarding whether the vehicle is driving on the turnable road, and the map information provider may be configured to provide map information from navigation map data or cloud map data .

Further, the first sensor may comprise at least one of a front camera, a front radar, or a corner radar, and the second sensor comprises a steering angle sensor configured to sense a steering angle of the vehicle, and an accelerator pedal sensor configured to sense whether the accelerator pedal of the vehicle is operated.

Further, the controller may be further configured to determine whether acceleration of the vehicle is greater than or equal to a predetermined acceleration in response to determining that the driver has operated the accelerator pedal, and release the deactivation condition of the AEB system in response to determining that the acceleration of the vehicle is greater than or equal to a predetermined acceleration.

Further, the turnable road may be an intersection, an entrance or exit of a parking lot, or a road within a residential complex.

Further, the target may be another vehicle in front of the vehicle, a pedestrian, a bicycle, or an electric kickboard.

Further, the controller may be configured to determine that the predetermined turning condition is satisfied in response to determining that a speed of the vehicle is less than or equal to a predetermined threshold value and the steering angle of the vehicle is greater than or equal to a predetermined angle.

Further, the predetermined threshold value for the speed of the vehicle may be 30 km/h.

Further, the controller may be connected with a braking apparatus of the vehicle and a warning apparatus of the vehicle, the braking apparatus may be configured to control braking of the vehicle, the warning apparatus may be configured to provide a notification to the driver of the vehicle, and the controller may be configured to control the braking apparatus or the warning apparatus to perform control according to the AEB system for the vehicle in response to a predetermined AEB system operation condition being satisfied for the target after the deactivation condition of the AEB system is released.

Meanwhile, in a non-transitory computer-readable recording medium that records a program for executing a method for preventing deactivation of an Autonomous Emergency Braking system of a vehicle according to an embodiment of the present disclosure on a computer, the method comprises: determining whether the vehicle is driving on a turnable road on which the vehicle is able to make a turn; recognizing a target on a driving path of the vehicle; determining whether the vehicle satisfies a predetermined turning condition; determining whether a driver of the vehicle has operated an accelerator pedal of the vehicle; and in response to determining that (i) the vehicle is driving on the turnable road, (ii) the recognized target is on the driving path of the vehicle, (iii) the vehicle satisfies the predetermined turning condition and (iv) the driver has operated the accelerator pedal, releasing a deactivation condition of the AEB system due to operation of the accelerator pedal in order to prevent deactivation of the AEB system.

The above-described means for solving the problem is only exemplary and should not be construed as limiting the present disclosure. In addition to the exemplary embodiments described above, additional embodiments may exist in the drawings and the following detailed description.

According to the means for solving the problems of the present disclosure described above, by preventing the Autonomous Emergency Braking system from being deactivated by the driver's accelerator pedal operation for a suddenly approaching target in a turning situation of an ego vehicle, it is possible to provide a method and system for preventing deactivation of an Autonomous Emergency Braking system that can prevent accidents due to sudden acceleration in unexpected situations.

Furthermore, according to the present disclosure, by solving the problem that the existing AEB system does not operate because it misinterprets pedal misoperation as an intention to avoid collision, it is possible to provide a method and system for preventing deactivation of an AEB system that can improve the reliability and responsiveness of the AEB system, and thereby improve the driving stability of the driver.

However, the effects obtainable from the present disclosure are not limited to the effects described above, and other effects may exist.

### BRIEF DESCRIPTION OF THE DRAWINGS

FIG. 1 is a control flowchart showing a method for preventing deactivation of an Autonomous Emergency Braking (AEB) system of a vehicle according to an embodiment of the present disclosure.

FIG. 2 is a control flowchart more specifically showing a road condition determination step in the method for preventing deactivation of the AEB system of a vehicle according to the embodiment of the present disclosure.

FIG. 3 is a control flowchart more specifically showing a turning condition determination step in the method for preventing deactivation of the AEB system of a vehicle according to the embodiment of the present disclosure.

FIG. 4 is a diagram showing a driving scenario when a target is recognized on a path during turning of a vehicle in the method for preventing deactivation of the AEB system of a vehicle according to the embodiment of the present disclosure.

FIG. 5 is a control configuration diagram schematically showing the configuration of a system for preventing deactivation of an AEB system of a vehicle according to embodiments of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part "includes" a certain component, it does not mean excluding other components, and it does mean that it may further include other components, unless otherwise stated.

Various embodiments of the present disclosure generally relate to a method and system for preventing deactivation of an Autonomous Emergency Braking (AEB) system, which prevents AEB system deactivation due to accelerator pedal operation when a target exists on a path in a situation where a vehicle is performing turning.

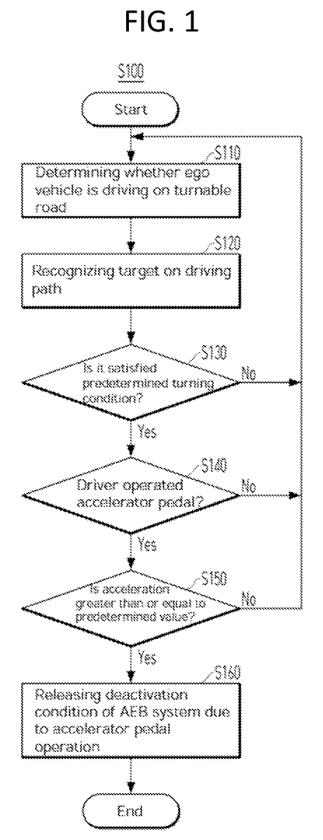

FIG. 1 is a control flowchart showing a method for preventing deactivation of an Autonomous Emergency Braking (AEB) system of a vehicle according to an embodiment of the present disclosure.

Referring to FIG. 1, a method for preventing deactivation of an autonomous emergency braking system of a vehicle S100 according to an embodiment of the present disclosure may comprise a road condition determination step of determining whether a vehicle (ego vehicle) is driving on a turnable road on which the vehicle is able to make a turn S110.

Specifically, the vehicle may be equipped with a navigation map or a High-Definition Map (HD Map), and may determine whether the vehicle is driving on a turnable road from navigation map data or cloud map data of the High-Definition Map.

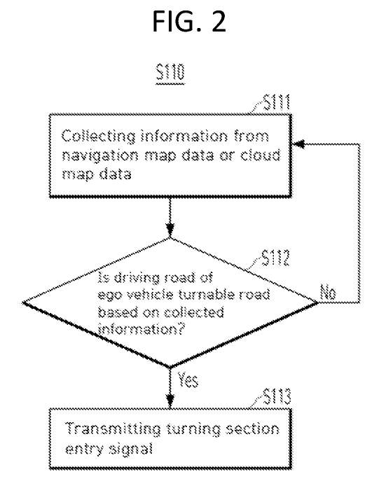

Referring to FIG. 2, the road condition determination step S110 will be described in more detail. FIG. 2 is a control flowchart more specifically showing a road condition determination step in the method for preventing deactivation of the AEB system of a vehicle according to the embodiment of the present disclosure.

Referring to FIG. 2, the road condition determination step S110 may comprise: collecting information from navigation map data or cloud map data S111; determining whether the driving road of the vehicle is a turnable road based on the collected information S112; and transmitting a turning section entry signal in response to determining that the driving road of the vehicle is a turnable road S113.

For example, the turnable road at which the vehicle (ego vehicle) is able to make a turn may be an intersection, an entrance or exit of a parking lot, or a road within a residential complex. However, the present disclosure is not limited thereto, and may include other types of roads if a pedestrian, bicycle, electric scooter, etc. may suddenly enter the driving path of the ego vehicle during turning.

In the case of roads such as the intersection, entrance or exit of a parking lot, or road within a residential complex as described above, these are roads where low-speed turning situations occur frequently, and where there is a high possibility that a pedestrian, bicycle, electric kickboard, etc., may suddenly enter the driving path when the ego vehicle is turning.

The type of road may be recognized from navigation map data or cloud map data, and if it is determined to be a turnable road, a turning section entry signal may be transmitted to inform the system that the vehicle has entered a turning section (a section that the turnable road exists).

Referring back to FIG. 1, if it is determined in the road condition determination step S110 that the vehicle is driving on a turnable road ('Yes' in S110), a target recognition step of recognizing a target on the driving path of the vehicle S120 may be performed.

Here, the driving path of the ego vehicle may be a turning path, and by recognizing a target suddenly entering the path during the turning of the ego vehicle, the control target of the Autonomous Emergency Braking (AEB) control may be detected.

Meanwhile, the target determination step S120 may include a step of determining whether there is a collision risk with the ego vehicle according to the predicted path of the target, and this is to enable setting a target with collision risk with the ego vehicle as a control target even when the predicted path of the target overlaps with the driving path of the ego vehicle.

Furthermore, the method for preventing deactivation of an AEB system according to the embodiment of the present disclosure may include a turning condition determination step of determining whether the vehicle satisfies a predetermined turning condition S130.

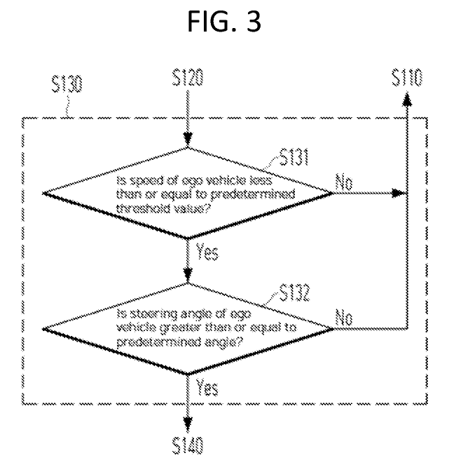

Here, determining whether the ego vehicle satisfies a predetermined turning condition is because accidents due to accelerator pedal misoperation occur frequently during turning (e.g., low-speed turning) of the ego vehicle on turning roads such as the entrance or exit of a parking lot, or roads within a residential complex mentioned earlier. The satisfaction of the predetermined turning condition(s) will be examined in detail with reference to FIG. 3.

FIG. 3 is a control flowchart more specifically showing a turning condition determination step in the method for preventing deactivation of the AEB system of a vehicle according to the embodiment of the present disclosure.

Referring to FIG. 3, the turning condition determination step S130 according to the embodiment of the present disclosure may include determining whether the speed of the vehicle is less than or equal to a predetermined threshold value S131, and determining whether the steering angle of the vehicle is greater than or equal to a predetermined angle S132.

Here, the predetermined threshold value regarding the speed of the ego vehicle may be 30 km/h. That is, the speed of the ego vehicle for satisfying the turning condition in the present disclosure may be a speed of 30 km/h or less (low-speed turning condition), for example. However, the present disclosure is not limited thereto, and the predetermined threshold value for the vehicle speed regarding the turning condition may be set differently as needed.

In addition, determining whether the steering angle of the ego vehicle is greater than or equal to a predetermined angle in step S132 is to determine whether the ego vehicle is performing turning. For example, the turning of the ego vehicle may be performing a right turn (or left turn), and therefore, an angle greater than or equal to a predetermined angle for performing a right turn (or left turn) may be determined as a turning angle.

Here, the predetermined angle here may be approximately 80 degrees to the left or right, for example, but is not limited thereto and may be set differently as needed. In the turning condition determination step S130 according to the embodiment of the present disclosure, if the speed of the ego vehicle is less than or equal to a predetermined threshold value ('Yes' in S131) and the steering angle of the ego vehicle is greater than or equal to a predetermined angle ('Yes' in S132), that is, in response to determining that the speed of the vehicle is less than or equal to a predetermined threshold value and the steering angle of the vehicle is greater than or equal to the predetermined angle, it may be determined that the predetermined turning condition is satisfied ('Yes' in S130), and the process may proceed to step S140. If either one is not satisfied, the process may return to step S110.

Referring back to FIG. 1, if the turning condition is satisfied ('Yes' in S130), an accelerator pedal operation determination step of determining whether the driver of the ego vehicle has operated the accelerator pedal S140 may be performed.

Here, the accelerator pedal operation determination step S140 may be performed by sensing the pedal pressure of the accelerator pedal by, for example, an accelerator pedal sensor. This is to determine whether the accelerator pedal has been operated by the driver.

If accelerator pedal operation by the driver is determined in the accelerator pedal operation determination step S140 ('Yes' in S140), in response to determining that (i) the vehicle is driving on the turnable road, (ii) the recognized target is on the driving path of the vehicle, (iii) the vehicle satisfies the predetermined turning condition and (iv) the driver has operated the accelerator pedal, an AEB deactivation condition release step of releasing the deactivation condition of the AEB system due to accelerator pedal operation S160 may be performed, in order to prevent deactivation of the AEB system due to accelerator pedal operation.

Meanwhile, as shown in FIG. 1, after the accelerator pedal operation determination step S140, it may further include determining whether the acceleration of the ego vehicle is greater than or equal to a predetermined acceleration S150, and the AEB deactivation condition release step S160 may be performed if it is determined that the acceleration of the ego vehicle is greater than or equal to a predetermined acceleration ('Yes' in S150).

By determining whether the acceleration of the ego vehicle is greater than or equal to a predetermined acceleration and by preventing the deactivation of the AEB system when sudden acceleration (when the acceleration is greater than or equal to the predetermined acceleration) is performed, it is possible to prevent accidents with high risk in advance.

Furthermore, after the AEB deactivation condition is released by the AEB deactivation condition release step, when a predetermined AEB system operation condition is satisfied for the target on the driving path of the ego vehicle, at least one of a warning control or a braking control according to the AEB system may be performed for the ego vehicle.

Meanwhile, the predetermined AEB system operation condition may be satisfied when the speed of the ego vehicle satisfies the AEB system operable speed and the estimated time to collision (Time To Collision; TTC) with the target is within a predetermined time.

The AEB system operable speed range may differ depending on the type of the target. For example, if the front target is a vehicle (another vehicle in front of the ego vehicle), the range may be approximately 10 to 85 km/h, and if the front target is a pedestrian or a bicycle, the range may be approximately 10 to 65 km/h. Meanwhile, the speed of the ego vehicle as the AEB system operation condition is not limited thereto and may be set differently.

Furthermore, if the TTC with the target is within a predetermined time (e.g., approximately 2 seconds), the AEB system may operate, and a warning control according to the AEB may be performed first, and if the TTC is within approximately 1.5 seconds, a braking control according to the AEB may be performed. Meanwhile, the TTC as the AEB system operation condition is not limited thereto and may be set differently.

According to the embodiments of the present disclosure as described above, by releasing the deactivation condition of the AEB system due to accelerator pedal operation, it is possible to prevent AEB deactivation due to misoperation of the accelerator pedal in a turning situation, thereby enabling safe driving.

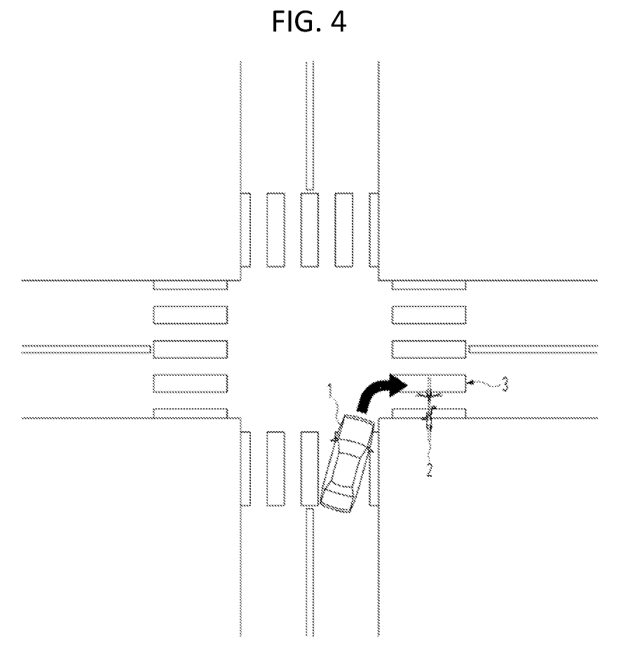

FIG. 4 is a diagram showing a driving scenario when a target is recognized on a path during turning of a vehicle in the method for preventing deactivation of the AEB system of a vehicle according to the embodiment of the present disclosure.

Referring to FIG. 4, a case is illustrated where the ego vehicle is performing a right turn at an intersection (a 4-Way Intersection is shown as an example).

For example, when the ego vehicle 1 is performing a right turn, a bicycle (target) 2 may enter the turning path (driving path) of the ego vehicle 1 to cross a crosswalk 3.

In this case, the bicycle 2 may be detected by a sensor equipped in the ego vehicle, and when it is determined that a predetermined turning condition is satisfied, if it is determined that the driver of the ego vehicle 1 has operated the accelerator pedal, the deactivation condition of the Autonomous Emergency Braking system (AEB) due to accelerator pedal operation may be released. Optionally, the deactivation condition of the AEB system by operating the accelerator pedal may be released when the acceleration of the ego vehicle 1 exceeds a predetermined acceleration.

That is, since the AEB deactivation condition due to accelerator pedal misoperation is released, if a predetermined AEB operation condition (TTC determination, etc.) is satisfied, braking control (including warning control) according to AEB may be performed despite the accelerator pedal operation.

Accordingly, in a low-speed turning driving scenario where accidents are prone to occur, it is possible to prevent accidents due to pedal misoperation and improve the reliability and responsiveness of the AEB system.

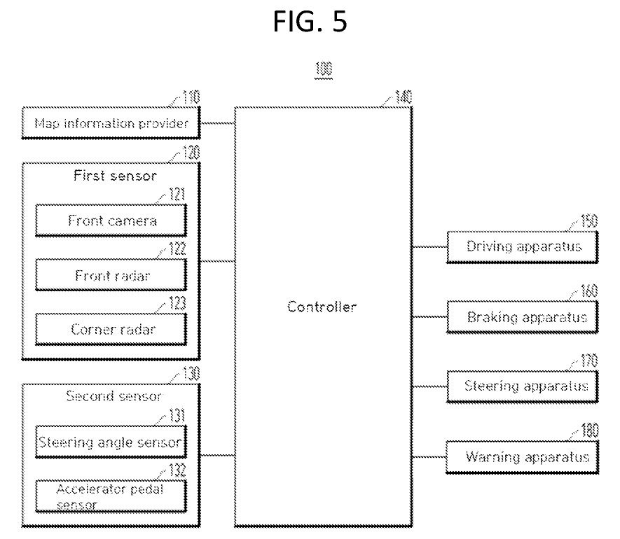

FIG. 5 is a control configuration diagram schematically showing the configuration of a system for preventing deactivation of an AEB system of a vehicle according to embodiments of the present disclosure.

Referring to FIG. 5, a system for preventing deactivation of an Autonomous Emergency Braking (AEB) system of a vehicle 100 according to embodiments of the present disclosure may comprise: a map information provider 110 configured to provide data regarding whether a vehicle is driving on a turnable road; a first sensor 120 configured to recognize a target on a driving path of the vehicle; a second sensor 130 configured to provide body information of the vehicle; and a controller 140 configured to control the AEB system of the vehicle. In some embodiments, the controller 140 comprises one or more of an Electronic Control Unit (ECU), a computer, a processor, and a microprocessor. In at least one embodiment, the map information provider 110 comprises a storage device such as a computer-readable recording medium.

The controller 140 may determine whether the vehicle satisfies a predetermined turning condition, and determine whether a driver of the vehicle has operated an accelerator pedal of the vehicle, and in response to determining that the vehicle satisfies the predetermined turning condition and the driver has operated the accelerator pedal, release a deactivation condition of the AEB system due to the accelerator pedal operation in order to prevent deactivation of the AEB system.

The map information provider 110 may include a navigation map or a High-Definition Map (HD Map), and may provide map information from navigation map data or cloud map data of the HD Map.

The first sensor 120 may include at least one of a front camera 121, a front radar 122, or a corner radar 123. However, the sensors included in the first sensor 120 are not limited thereto, and the first sensor 120 may further include other types of sensors for sensing the surroundings of the vehicle, such as a lidar sensor, an ultrasonic sensor, etc.

The second sensor 130 may include a steering angle sensor 131 configured to sense a steering angle of the ego vehicle and an accelerator pedal sensor 132 configured to sense whether the accelerator pedal of the ego vehicle is operated. However, the sensors included in the second sensor 130 are not limited thereto, and may further include other types of sensors for sensing the body information of the ego vehicle, such as a vehicle speed sensor, a brake pedal sensor, a turn signal sensor, etc.

In addition, the controller 140 may further determine whether an acceleration of the ego vehicle is greater than or equal to a predetermined acceleration (predetermined value) in response to determining that the driver has operated the accelerator pedal, and may release the deactivation condition of the AEB system in response to determining that the acceleration of the ego vehicle is greater than or equal to the predetermined acceleration.

Furthermore, the controller 140 may determine that the predetermined turning condition is satisfied in response to determining that the speed of the ego vehicle is less than or equal to a predetermined threshold value and the steering angle of the ego vehicle is greater than or equal to a predetermined angle.

The predetermined threshold value for the speed of the ego vehicle in the predetermined turning condition may be 30 km/h, but is not limited thereto and may be set differently as needed.

Furthermore, the controller 140 may be connected to a driving apparatus 150 configured to control longitudinal driving of the ego vehicle, a braking apparatus 160 configured to control braking of the ego vehicle, and a steering apparatus 170 configured to control lateral driving of the ego vehicle. The braking apparatus 160 may be controlled to perform braking control of the ego vehicle under AEB system operation conditions.

Furthermore, the controller 140 may be connected to a warning apparatus 180 configured to provide a notification to the driver of the ego vehicle. The warning apparatus 180 may include at least one of a visual warning device, an audible warning device, or a haptic warning device, and may activate the at least one warning device individually or simultaneously under AEB system operation conditions.

That is, the controller 140 may control the braking apparatus 160 or the warning apparatus 180 to perform control according to the Autonomous Emergency Braking (AEB) system for the ego vehicle in response to a predetermined AEB system operation condition being satisfied for the target after the deactivation condition of the AEB system is released.

Regarding the method for preventing deactivation of the Autonomous Emergency Braking (AEB) system according to the embodiment of the present disclosure performed by the controller 140, since it has been described in detail previously, a detailed description thereof will be omitted here.

The disclosed embodiments may also be implemented as a computer-readable program on a computer-readable recording medium in order to be executed by a computer. A computer-readable recording medium may be a non-transitory computer-readable recording medium, such as a data storage device capable of storing data that may be read by a processor/microprocessor.

Examples of computer-readable recording media may include hard disk drives (HDD), solid-state drives (SSD), silicon disk drives (SDD), read-only memory (ROM), CD-ROM, magnetic tape, floppy disks, optical data storage devices, etc.

According to the embodiments of the present disclosure as described above, in blind spots such as intersections, by appropriately operating AEB even in a situation of driver's pedal misoperation due to the sudden approach of vulnerable road users such as pedestrians, electric kickboards, and bicycles, it is possible to provide a method and system for preventing deactivation of an Autonomous Emergency Braking system that can prevent serious accidents due to sudden acceleration that may occur in unexpected situations.

Furthermore, according to the embodiments of the present disclosure, it is possible to prevent accidents due to pedal misoperation that may occur due to decreased cognitive ability and reflexes of elderly drivers or pedal misoperation in situations where the driver is distracted, and thus, it is possible to provide the method and system for preventing deactivation of an Autonomous Emergency Braking system that can improve the safety of the driver and the safety of surrounding road users.

Moreover, according to the method and system for preventing deactivation of the AEB system according to the embodiments of the present disclosure, by solving the problem that the existing AEB system does not operate emergency braking because it misinterprets the pedal misoperation as an intention to avoid collision, it is possible to improve the reliability and responsiveness of the AEB system, and also reduce traffic congestion by reducing accidents at intersections and parking lot entrances/exits, and achieve reducing social costs due to the accidents.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

What is claimed is:

1. A method of preventing deactivation of an Autonomous Emergency Braking (AEB) system of a vehicle, comprising:
determining whether the vehicle is driving on a turnable road on which the vehicle is able to make a turn;
recognizing a target on a driving path of the vehicle;
determining whether the vehicle satisfies a predetermined turning condition;
determining whether a driver of the vehicle has operated an accelerator pedal of the vehicle; and
in response to determining that (i) the vehicle is driving on the turnable road, (ii) the recognized target is on the driving path of the vehicle, (iii) the vehicle satisfies the predetermined turning condition and (iv) the driver has operated the accelerator pedal,
releasing a deactivation condition of the AEB system due to operation of the accelerator pedal in order to prevent deactivation of the AEB system.

2. The method of claim 1, wherein the determining whether the vehicle is driving on the turnable road comprises:
collecting information from navigation map data or cloud map data;
determining whether a driving road of the vehicle is the turnable road based on the collected information; and
transmitting a turning section entry signal in response to determining that the driving road of the vehicle is the turnable road.

3. The method of claim 2, wherein the turnable road is an intersection, an entrance or exit of a parking lot, or a road within a residential complex.

4. The method of claim 3, wherein the recognizing of the target comprises determining whether there is a collision risk with the vehicle according to a predicted path of the target.

5. The method of claim 4, wherein the target is another vehicle in front of the vehicle, a pedestrian, a bicycle, or an electric kickboard.

6. The method of claim 5, wherein the determining whether the vehicle satisfies the predetermined turning condition comprises:
determining whether a speed of the vehicle is less than or equal to a predetermined threshold value;
determining whether a steering angle of the vehicle is greater than or equal to a predetermined angle; and
in response to determining that the speed of the vehicle is less than or equal to a predetermined threshold value and the steering angle of the vehicle is greater than or equal to the predetermined angle,
determining that the vehicle satisfies the predetermined turning condition.

7. The method of claim 6, wherein the predetermined threshold value for the speed of the vehicle is 30 km/h.

8. The method of claim 7, wherein the determining whether the driver of the vehicle has operated the accelerator pedal is performed by an accelerator pedal sensor equipped in the vehicle, the accelerator pedal sensor sensing whether the accelerator pedal is operated.

9. The method of claim 1, further comprising:
in response to determining that the driver of the vehicle has operated the accelerator pedal, determining whether acceleration of the vehicle is greater than or equal to a predetermined acceleration,
wherein the releasing of the deactivation condition of the AEB system is performed in response to determining that the acceleration of the vehicle is greater than or equal to the predetermined acceleration.

10. The method of claim 9, further comprising:
after the deactivation condition of the AEB system is released by the releasing of the deactivation condition of the AEB system, and in response to a predetermined AEB system operation condition being satisfied for the target,
performing at least one of a warning control or a braking control according to the AEB system for the vehicle.

11. A system for preventing deactivation of an Autonomous Emergency Braking (AEB) system of a vehicle, comprising:
a first sensor configured to recognize a target on a driving path of the vehicle;
a second sensor configured to provide body information of the vehicle; and
a controller configured to control the AEB system of the vehicle,
wherein when the vehicle is driving on a turnable road, the controller is configured to
determine whether the vehicle satisfies a predetermined turning condition,
determine whether a driver of the vehicle has operated an accelerator pedal of the vehicle, and
in response to determining that the vehicle satisfies the predetermined turning condition and the driver has operated the accelerator pedal, release a deactivation condition of the AEB system due to accelerator pedal operation in order to prevent deactivation of the AEB system.

12. The system of claim 11, further comprising:
a map information provider configured to provide data regarding whether the vehicle is driving on the turnable road,
wherein the map information provider is configured to provide map information from navigation map data or cloud map data.

13. The system of claim 11, wherein
the first sensor comprises at least one of a front camera, a front radar, or a corner radar, and
the second sensor comprises a steering angle sensor configured to sense a steering angle of the vehicle, and an accelerator pedal sensor configured to sense whether the accelerator pedal of the vehicle is operated.

14. The system of claim 13, wherein the controller is further configured to
determine whether acceleration of the vehicle is greater than or equal to a predetermined acceleration in response to determining that the driver has operated the accelerator pedal, and
release the deactivation condition of the AEB system in response to determining that the acceleration of the vehicle is greater than or equal to a predetermined acceleration.

15. The system of claim 14, wherein the turnable road is an intersection, an entrance or exit of a parking lot, or a road within a residential complex.

16. The system of claim 15, wherein the target is another vehicle in front of the vehicle, a pedestrian, a bicycle, or an electric kickboard.

17. The system of claim 16, wherein the controller is configured to determine that the predetermined turning condition is satisfied in response to determining that a speed of the vehicle is less than or equal to a predetermined threshold value and the steering angle of the vehicle is greater than or equal to a predetermined angle.

18. The system of claim 17, wherein the predetermined threshold value for the speed of the vehicle is 30 km/h.

19. The system of claim 18, wherein
the controller is connected with a braking apparatus of the vehicle and a warning apparatus of the vehicle,
the braking apparatus is configured to control braking of the vehicle,
the warning apparatus is configured to provide a notification to the driver of the vehicle, and
the controller is configured to control the braking apparatus or the warning apparatus to perform control according to the AEB system for the vehicle in response to a predetermined AEB system operation condition being satisfied for the target after the deactivation condition of the AEB system is released.

20. A non-transitory computer-readable recording medium storing a program for causing a computer to execute a method of preventing deactivation of an Autonomous Emergency Braking (AEB) system of a vehicle, the method comprising:
determining whether an vehicle is driving on a turnable road on which the vehicle is able to make a turn;
recognizing a target on a driving path of the vehicle;
determining whether the vehicle satisfies a predetermined turning condition;
determining whether a driver of the vehicle has operated an accelerator pedal of the vehicle; and
in response to determining that (i) the vehicle is driving on the turnable road, (ii) the recognized target is on the driving path of the vehicle, (iii) the vehicle satisfies the predetermined turning condition and (iv) the driver has operated the accelerator pedal,
releasing a deactivation condition of the AEB system due to operation of the accelerator pedal in order to prevent deactivation of the AEB system.
